(19) United States
(12) Patent Application Publication
(10) Pub. No.: US 2026/0200773 A1
(43) Pub. Date: Jul. 16, 2026

(54) OZONE FAUCET INCLUDING A GAS MITIGATION FAN

(71) Applicant: Delta Faucet Company, Indianapolis, IN (US)

(72) Inventors: Michael Scot Rosko, Greenwood, IN (US); Jacob Rosko, Geenwood, IN (US)

(21) Appl. No.: 19/138,366

(22) PCT Filed: Nov. 15, 2023
(86) PCT No.: PCT/US2023/079791

§ 371 Date: Jun. 12, 2025

Related U.S. Application Data
(60) Provisional application No. 63/432,544, filed on Dec. 14, 2022.

(51) Int. Cl. C02F 1/78

(52) U.S. Cl. CPC C02F 1/78; C02F 2201/782; C02F 2209/003; C02F 2209/235; C02F 2307/06

(57) ABSTRACT

A faucet system including a faucet operably coupled to an air movement device and, more particularly, to an ozone faucet including an integrated fan to help mitigate the off-gassing of ozone from the discharged water.

### CROSS-REFERENCE TO RELATED APPLICATION

The present application claims priority to U.S. Provisional Patent Application Ser. No. 63/432,544, filed Dec. 14, 2022, the disclosure of which is expressly incorporated herein by reference.

### BACKGROUND AND SUMMARY OF THE DISCLOSURE

The present invention relates generally to an ozone faucet and, more particularly, to an ozone faucet including an integrated fan to help mitigate the off-gassing of ozone from the discharged water.

Fluid delivery devices, such as faucets, may include a fluid treatment device for improving water quality. For example, the fluid treatment device may be an ozone generator used to disinfect and/or sanitize by destroying bacteria and viruses present in the water. Ozone water treatment for potable water is known in the art.

In an ozone faucet, there can be ozone “plumes” of high concentration gas close to the faucet where the ozone generation is occurring. The present disclosure relates to an ozone faucet including a gas mitigation fan to blow ozone gas away from the sink area into larger spaces of the room to help dissipate the ozone gas that escapes from the water.

Such a fan is configured to reduce the ozone gas concentration in the air where a consumer would typically be standing.

According to an illustrative embodiment of the present disclosure, a faucet system includes a faucet having a faucet body with a spout configured to deliver fluid from an outlet. A water treatment device is fluidly coupled to the faucet. A controller is in electrical communication with the water treatment device and is configured to control the water treatment device. An air movement device is supported by the faucet body and is in electrical communication with the controller. The air movement device illustratively includes a fan having an air inlet and an air outlet, a motor, a shaft, and a propeller. The air outlet of the air movement device is directed to the water delivered from the outlet of the spout.

According to another illustrative embodiment of the present disclosure, a faucet system includes a faucet having a spout with a water outlet, and an ozone generator fluidly coupled to the faucet and configured to provide ozone in water delivered from the water outlet. A controller is operably coupled to the ozone generator, and a fan is operably coupled to the controller. The fan includes an air inlet, an air outlet, an electric motor, a shaft rotatably supported by the motor, and a propeller operably coupled to the shaft. The propeller is positioned intermediate the air inlet and the air outlet.

According to a further illustrative embodiment of the present disclosure, a faucet includes a hub, a spout supported by the hub and including a water outlet, and a fan supported by the hub. The fan includes an air inlet, an air outlet, an electric motor, a shaft rotatably supported by the motor, and a propeller operably coupled to the shaft and positioned intermediate the air inlet and the air outlet. The air outlet of the fan is directed to water delivered from the water outlet.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a front perspective view of an illustrative ozone faucet system of the present disclosure shown supported by a sink deck;

FIG. 2 is a rear perspective view of the ozone faucet system of FIG. 1;

FIG. 3 is a partial cross-sectional view taken along line 3-3 of FIG. 2;

FIG. 4 is a cross-sectional view taken along line 4-4 of FIG. 2;

FIG. 5 is a diagrammatic view of the illustrative ozone faucet system of FIG. 1;

FIG. 6 is a front perspective view of an illustrative ozone faucet system of the present disclosure shown supported by a sink deck;

FIG. 7 is a rear perspective view of the ozone faucet system of FIG. 6;

FIG. 8 is a partial cross-sectional view taken along line 8-8 of FIG. 7;

FIG. 9 is a cross-sectional view taken along line 9-9 of FIG. 7;

FIG. 10 is a front perspective view of an illustrative ozone faucet system of the present disclosure shown supported by a sink deck;

FIG. 11 is a rear perspective view of the illustrative ozone faucet system of FIG. 10;

FIG. 12 is a partial cross-sectional view taken along line 12-12 of FIG. 11;

FIG. 13 is a partial cross-sectional view taken along line 13-13 of FIG. 11;

FIG. 14 is a front perspective view of an illustrative ozone faucet system of the present disclosure shown supported by a sink deck;

FIG. 15 is a rear perspective view of the illustrative ozone faucet system of FIG. 13;

FIG. 16 is a partial cross-sectional view taken along line 16-16 of FIG. 15; and

FIG. 17 is a cross-sectional view taken along line 17-17 of FIG. 15.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

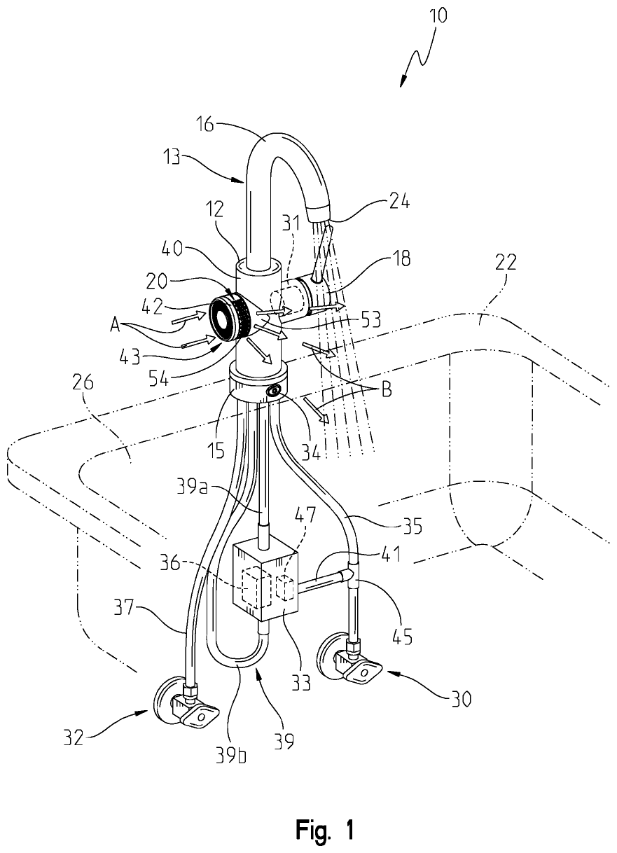

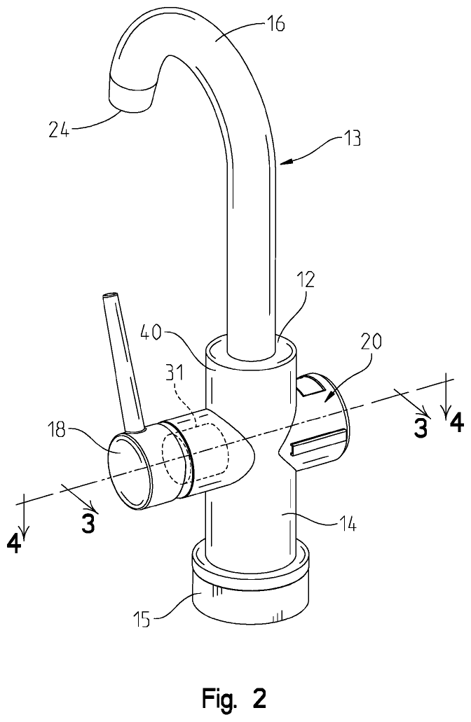

Referring initially to FIGS. 1 and 2, an illustrative embodiment ozone faucet system 10 is shown including a faucet 12. Faucet 12 illustratively includes a faucet body 13 including a hub 14 supported by a base 15. Faucet body 13 illustratively includes a delivery spout 16 supported by the hub 14. Delivery spout 16 may be fixed relative to the hub 14 or moveable relative to the hub 14. For example, the delivery spout 16 may be supported for rotation relative to the hub 14. Illustrative faucet 12 also includes a valve control handle 18 and an air movement device, such as a fan 20. Faucet 12 may be mounted to a sink deck 22 or other suitable mounting surface with delivery spout 16 positioned to direct water from a water outlet 24 into a conventional sink basin 26 or other area, for example.

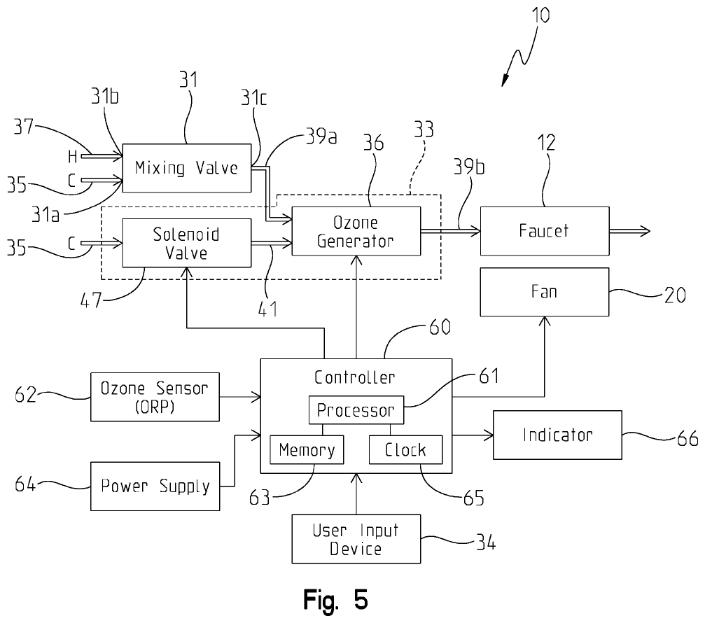

A cold water source 30 and a hot water source 32 provide cold water and hot water, respectively, to the faucet 12. More particularly, the cold water source 30 is fluidly coupled to a cold water inlet 31a of a mixing valve 31 of the faucet 12, and the hot water source 32 is fluidly coupled to a hot water inlet 31b of a mixing valve 31 of the faucet 12 (FIG. 5). Cold water and hot water inlet tubes 35 and 37 may be fluidly coupled to cold water and hot water sources 30 and 32, respectively, for receiving water into the mixing valve 31 of the faucet 12.

With reference to FIGS. 1, 2 and 5, the mixing valve 31 is illustratively positioned within the hub 14. The mixing valve 31 may be a conventional mixing valve that uniformly mixes the cold and hot water entering inlets 31a, 31b from inlet tubes 35, 37, respectively. Inlet tubes 35, 37 may include conventional fluid couplings, such as end adapters and nuts, for fluidly coupling to hot and cold water supplies 30, 32, respectively.

The control handle 18 is coupled to the mixing valve 31 for dispensing water from the outlet 24 of the spout 16 into the sink basin 26. More particularly, user operation of the handle 18 controls the flow rate and/or temperature of water discharged from the water outlet 24. An illustrative mixing valve 31 is further detailed in U.S. Pat. No. 7,753,074 to Rosko et al., the disclosure of which is expressly incorporated herein by reference.

The ozone faucet system 10 illustratively includes a water treatment device 33 (FIGS. 1 and 5), and more particularly, a disinfectant device such as an antibacterial device. The water treatment device 33 may include an ozone device having an electrolytic ozone generator or cell 36. In one illustrative embodiment, the water treatment device 33, including the ozone generator 36, is positioned below the sink deck 22. The ozone generator 36 may be removable from the water treatment device 33 for replacement. Illustratively, the ozone generator 36 may be of the type detailed in U.S. Pat. No. 9,919,939 to Rosko et al., the disclosure of which is expressly incorporated herein by reference.

With reference to FIGS. 1, 3 and 5, the faucet body 13 illustratively includes a user input device 34. When a user presses the user input device 34, the water treatment device 33 is activated. Illustratively, the user input device 34 is a button, switch or dial supported on the base 15. Illustratively, the user input device 34 is a push button. In one illustrative embodiment, the user input device 34 utilizes capacitive sensing and, for example, activates the water treatment device 33 when a user double taps the faucet body 13. In one illustrative embodiment, the user input device 34 includes a light emitting diode (LED) that illuminates when the water treatment device 33 is in operation.

With further reference to FIGS. 1 and 5, an illustrative outlet tube 39 includes a first or upstream portion 39a and a second or downstream portion 39b. Both first and second portions 39a, 39b of outlet tube 39 are fluidly coupled to the water treatment device 33. More particularly, the first portion 39a extends between an outlet 31c of the mixing valve 31 and the water treatment device 33. As further detailed herein, in an illustrative embodiment, water from the first potion 39a flows through the ozone generator 36 to the second portion 39b. In another illustrative embodiment, water from the first portion 39a may bypass the ozone generator 36 and flow directly to the second portion 39b. The second portion 39b extends between the water treatment device 33 upwardly to pass through the faucet body 13 to deliver water at the water outlet 24 of the spout 16. A cold water tube 41 extends between the cold water inlet tube 35 and an inlet of the water treatment device 33.

The cold water tube 41 is fluidly coupled to the inlet tube 35 via a fluid connector 45. Fluid connector 45 may be any standard connector, for example, in one illustrative embodiment, the connector 45 is a T-connector.

In an illustrative operation, when the ozone generator 36 is active and thus the faucet system 10 is in a treatment mode, cold water flows from the cold water source 30 to the water treatment device 33 through cold water tube 41. The cold water illustratively flows directly to the ozone generator 36 via an electrically operable valve 47, illustratively a solenoid valve (FIGS. 1 and 5). In such an illustrative embodiment, the ozone generator 36 and the electrically operable valve 47 form part of the water treatment device 33. When the ozone generator 36 is not active and thus the faucet system 10 is in a non-treatment mode, water flows from the cold water source 30 and the hot water source 32 to the mixing valve 31 received within the hub 14 of faucet 12. The cold water and the hot water are then mixed within the mixing valve 31 as controlled by the user operating handle 18. Illustratively, the mixed water flows out of the mixing valve 31 through the first portion 39a of the outlet tube 39.

In one illustrative embodiment non-treatment mode, the mixed water flows from the mixing valve 31 through the ozone generator 36 when it is inactive, and thus is not treated. In another illustrative embodiment non-treatment mode, the mixed water from the mixing valve 31 does not pass through the ozone generator 36, and instead the mixed water simply bypasses the ozone generator 36 and is not treated. In both illustrative embodiments, the water from the water treatment device 33 flows back up through the second portion 39b of the outlet tube 39 within the spout 16 to be dispersed at the water outlet 24 into the sink basin 26.

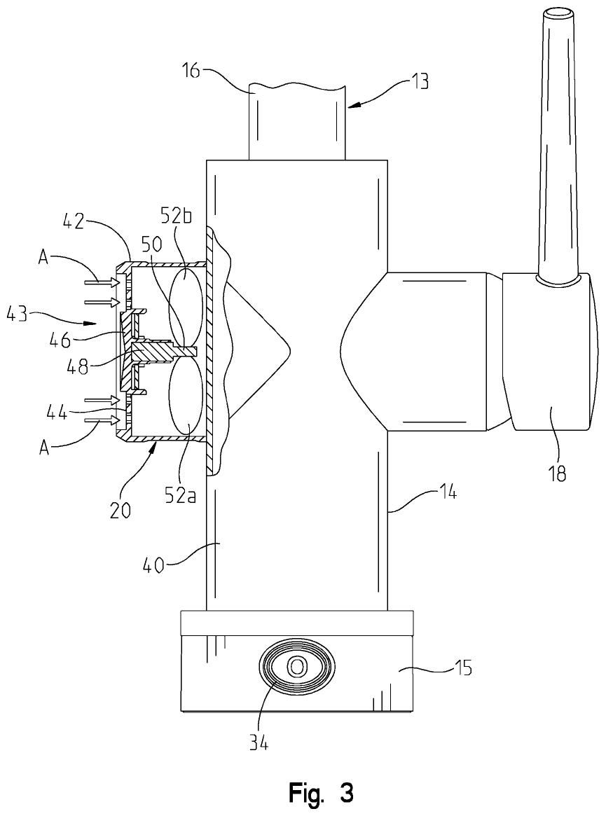

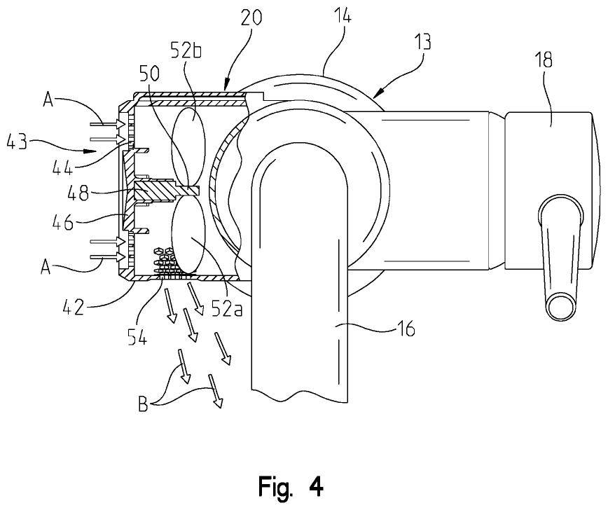

With reference to FIGS. 3 and 4, the fan 20 is illustratively positioned on the outer surface 40 of the hub 14. In an illustrative embodiment, the fan 20 is on a first side of the hub, diametrically opposed from the valve control handle 18. In one illustrative embodiment, the fan 20 is not attached to the faucet 12 and is positioned in spaced relation to the faucet 12 on the sink deck 22.

The illustrative fan 20 includes an outer housing 42 having an air inlet 43 with an inlet screen 44. Illustratively, the inlet screen 44 is disk shaped. The inlet screen 44 may be configured to focus airflow in a certain direction. A center bracket 46 supports an electric motor 48 and a rotatable shaft 50. A propeller 52 is attached to the shaft 50 and includes a plurality of individual blades or vanes 52a, 52b. The propeller 52 can consist of any number of blades. In an illustrative embodiment, the propeller 52 has four blades 52a, 52b, 52c, 52d disposed at 90 degree angles from each other. The outer housing 42 of the fan 20 also includes an air outlet 53 having an outlet screen 54. Illustratively, the outlet screen 54 is positioned annularly on the outer housing 42.

In operation, the electric motor 48 rotates the shaft 50 and, in turn, the propeller 52. As the propeller 52 turns, air pressure is created causing air pulled into the air inlet 43 via the inlet screen 44 (arrows A) and to flow out of the air outlet 53 via the outlet screen 54 (arrows B). In one illustrative embodiment, the fan 20 is a separate component from the hub 14. The fan 20 attaches to the hub 14 via any conventional method. In one illustrative embodiment, the fan 20 snaps into slots (not shown) on the hub 14. The hub 14 illustratively includes a hole (not shown) to feed electrical wires therethrough between the fan 20 and a controller 60 (FIG. 5). In another illustrative embodiment, the fan 20 is integrated into hub 14.

When the ozone generator 33 is in operation, ozone gas is created. To reduce the level of ozone gas in the area of the faucet 12 for a user, the fan 20 is used to blow the ozone gas away from the ozone faucet system 10 to disperse any plumes of high ozone concentration. By pushing the ozone gas away from the sink area into larger spaces of the room, there is a reduction in the ozone gas concentrations in the air near the user.

FIG. 5 is a diagrammatic view of operational components of the ozone faucet system 10. As previously described, cold and hot water enter the ozone faucet system 10 and are mixed through the mixing valve 31. The water from the mixing valve 31 then flows through the ozone generator 33 prior to exiting through the water outlet 24 of the faucet 12. The user input device 34 may be provided for controlled use of the ozone generator 33. The user input device 34 may be in the form of a button, switch, or any means where a user can indicate to the controller 60 to activate the ozone generator 33.

The controller 60 illustratively includes a processor 61, a memory 63 and a clock (and/or timer) 65. The controller 60 is in electrical communication with the ozone generator 36 and the solenoid valve 47 of the water treatment device 33, and with the fan 20. An indicator 66 may be in electrical communication with the controller 60 to provide an indication of operational status to the user. For example, the indicator 66 may provide an alert to the user if the fan 20 and/or the ozone generator 36 is not operating properly. The indicator 66 may be a visual indicator (e.g., a light or a display) and/or an audible indicator (e.g., a speaker). In certain illustrative embodiments, the controller 60 may turn off the ozone generator 36 if it detects that the fan 20 is not operating properly.

Illustratively, an ozone sensor 62 measures the ozone gas level and provides an indication thereof to the controller 60. In an illustrative embodiment, the ozone sensor 62 measures oxidation reduction potential (ORP) to determine the level of ozone concentration in the air near the water outlet 24 following use of the ozone generator 33. The controller 60 may activate the indicator 66 to provide to the user an indication of ozone gas levels measured by the ozone sensor 62. A power supply 64 is illustratively provided to power the controller 60 and, in turn, the ozone generator 33 and the electric motor 48 of the fan 20.

In one illustrative mode of operation, the controller 60 activates the fan 20 whenever the ozone generator 33 is in operation (i.e., on or active). In an illustrative embodiment, the controller 60 turns off the fan 20 after the ozone generator 33 shuts off (e.g., either immediately or after a predetermined time as determined by the clock 65). In another illustrative embodiment, the controller 60 turns the fan 20 off after a preset time of operation as determined by the clock 65. In another illustrative mode of operation, the controller 60 activates the fan 20 when the ozone sensor 62 detects ORP above a certain level. In certain illustrative embodiments, the controller 60 can vary fan speed based on inputs, such as time (e.g., as input from the clock 65) or detected ozone levels (e.g., as input from the ozone sensor 62).

In another illustrative mode of operation, the controller 60 may control operation of the ozone generator 36 and/or the fan 20 based on a duty cycle. More particularly, the processor 61 detects time of operation of the ozone generator 36 over a predetermined period measured by the clock 65, and compares the time of operation to a value stored in the memory 63. In an illustrative embodiment, once the ozone generator 36 is activated, the clock 65 measures 10 minutes. The illustrative controller 60 only permits for an accumulated 5 minutes of activation of the ozone generator 36 over the 10 minute period. Once the 10 minute time limit has been reached, the clock 65 is reset waiting for the next activation of the ozone generator 36.

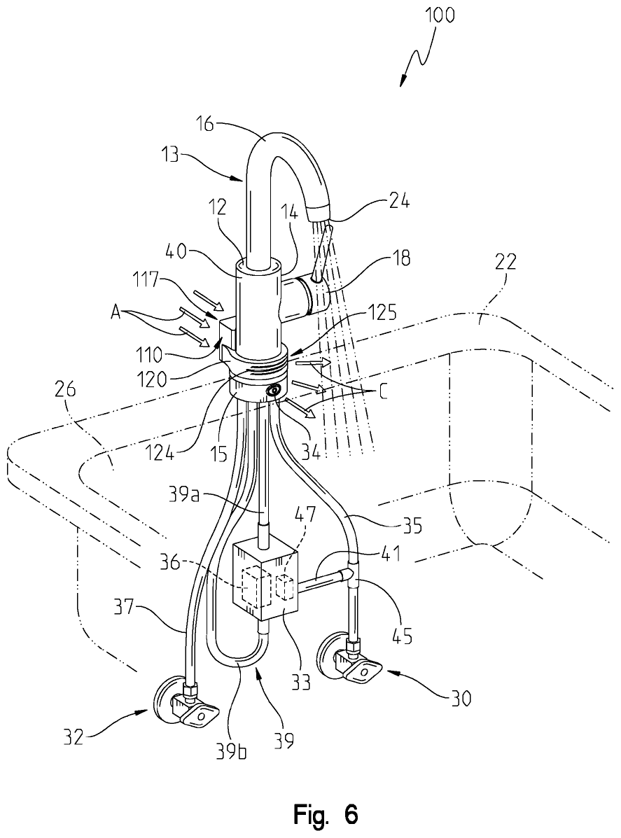

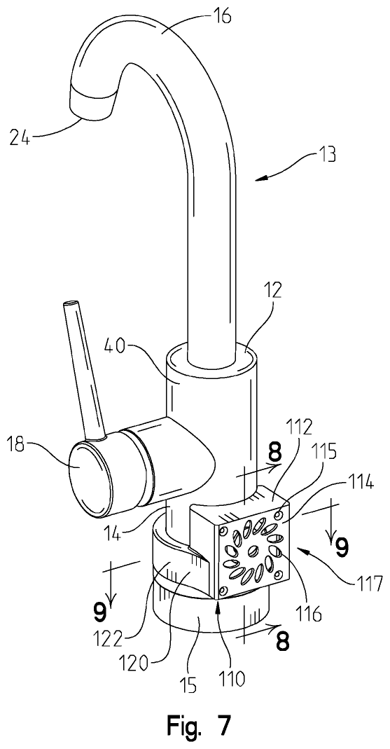

FIGS. 6-9 show another illustrative embodiment ozone faucet system 100 including many similar elements of the ozone faucet system 10 as detailed above. As such, in the following description, similar features are identified with like reference numbers.

A fan 110 is illustratively positioned on the outer surface 40 of the hub 14. A first fan housing 112 receives the motor 48, the shaft 50, and the propeller 52. A rear cover 114 of the first fan housing 112 includes a plurality of openings 116 defining an air inlet 117. The rear cover 114 is illustratively attached to the first fan housing 112 via conventional methods, such as, for example, screws 115. Illustratively, there are four screws 115 that couple the rear cover 114 to the housing 112. Illustratively, the first fan housing 112 is rectangular in shape. A second fan housing 120 is illustratively operably coupled to the first fan housing 112. The second fan housing 120 illustratively includes an arcuate section 122 configured to match the geometry of the hub 14 so that the second fan housing 120 can be coupled to the hub 14.

In one illustrative embodiment, the first fan housing 112 and the second fan housing 120 are integrated into the hub 14. In another illustrative embodiment, the first fan housing 112 and the second fan housing 120 are separate from the hub 14 and attached to the hub 14 via conventional methods. This allows fan 110 to be added onto an existing faucet 12. In yet other illustrative embodiments, the first fan housing 112 and the second fan housing 120 may be coupled to the spout 16, or to other components of the faucet 12, or positioned in speed relation to the faucet 12.

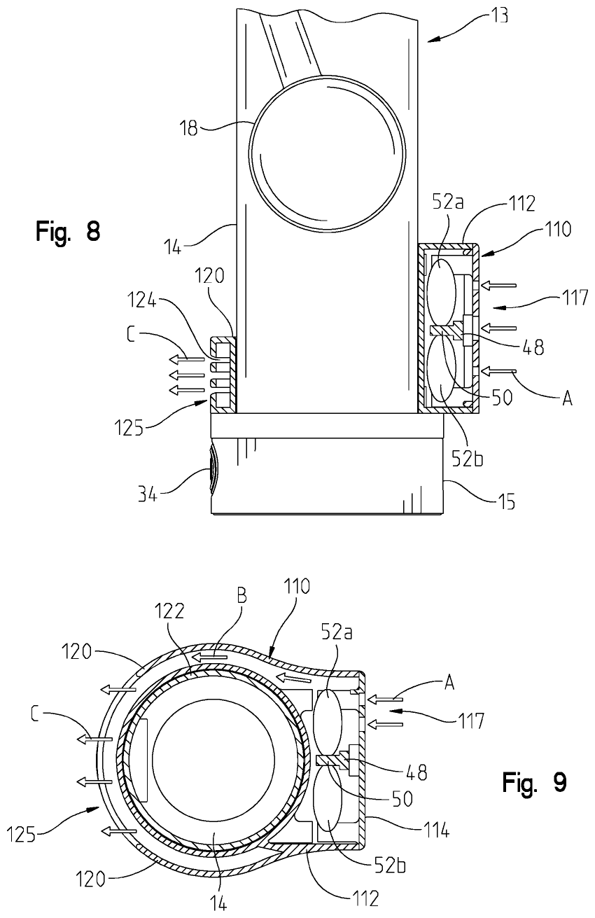

The second fan housing 120 illustratively includes a plurality of openings 124 defining an air outlet 125. Illustratively, the openings 124 face in the direction of the sink basin 22 (opposite the air inlet 117 of the first fan housing 112). Fan 110 works in a similar manner to fan 10 described in detail above. Air is pulled in through openings 116 of the air inlet 117 (arrows A). When operating, the fan 110 pushes the airflow through the second fan housing 120 (arrows B) around the circumference of the hub 14, and out the openings 124 of the air outlet 125 (arrows C) (FIGS. 8 and 9).

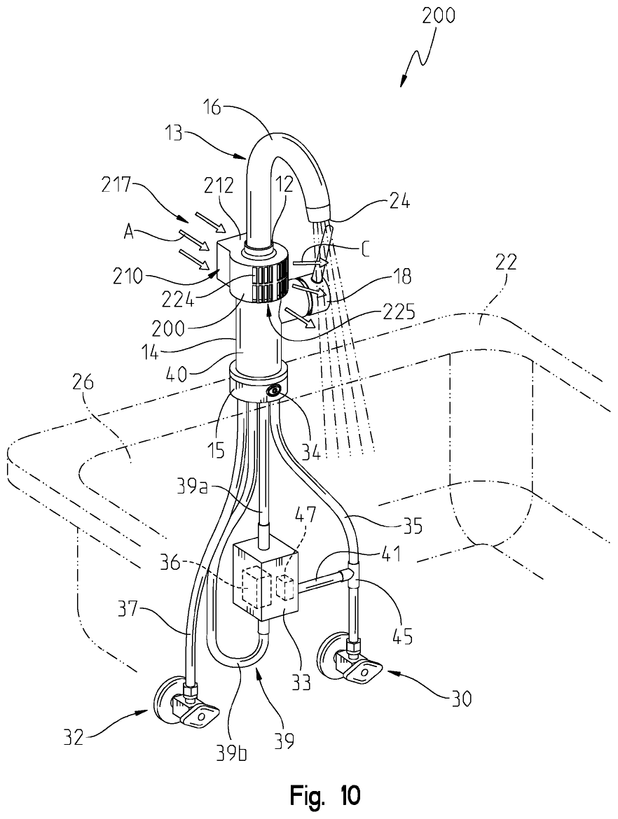

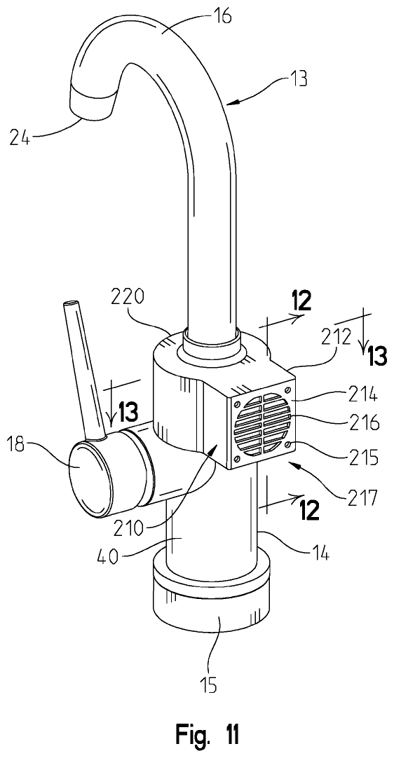

FIGS. 10-13 show another illustrative embodiment ozone faucet system 200 including many similar elements of the ozone faucet system 10 as detailed above. As such, in the following description, similar features are identified with like reference numbers.

A fan 210 is illustratively positioned on the outer surface 40 of the hub 14. A first fan housing 212 receives the motor 48, the shaft 50, and the propeller 52. A rear cover 214 of the first fan housing 212 includes a plurality of openings 216 defining an air inlet 217. The rear cover 214 is illustratively attached to the first fan housing 212 via conventional methods, such as, for example, screws 215. Illustratively, there are four screws 215 that couple the rear cover 214 to the first fan housing 212. Illustratively, the first fan housing 212 is rectangular in shape. A second fan housing 220 is operably coupled to the first fan housing 212. Illustratively, the second fan housing 220 includes an arcuate section 222 configured to match the geometry of the hub 14 so that the second fan housing 220 can be coupled to the hub 14.

In one illustrative embodiment, the first fan housing 212 and the second fan housing 220 are integrated into the hub 14. In another illustrative embodiment, the first fan housing 212 and the second fan housing 220 are separate from the hub 14 and attached to the hub 14 via conventional methods. This allows fan 210 to be added onto an existing faucet 12. In one illustrative embodiment, during assembly, the fan 210 is slid over the top of the hub 14 and is attached to the spout 16 with a set screw (not shown). In an illustrative embodiment, the fan 210 may be attached (e.g., clamped) to an outer surface of the spout 16. This would allow the fan 210 to move with the spout 16 when a user turns the spout 16, causing the fan 210 to always point at the water stream coming from the outlet 24 of the spout 16. In other illustrative embodiments, the first fan housing 212 and the second fan housing 220 may be coupled to other components of the faucet 12, or positioned in spaced relation to the faucet 12.

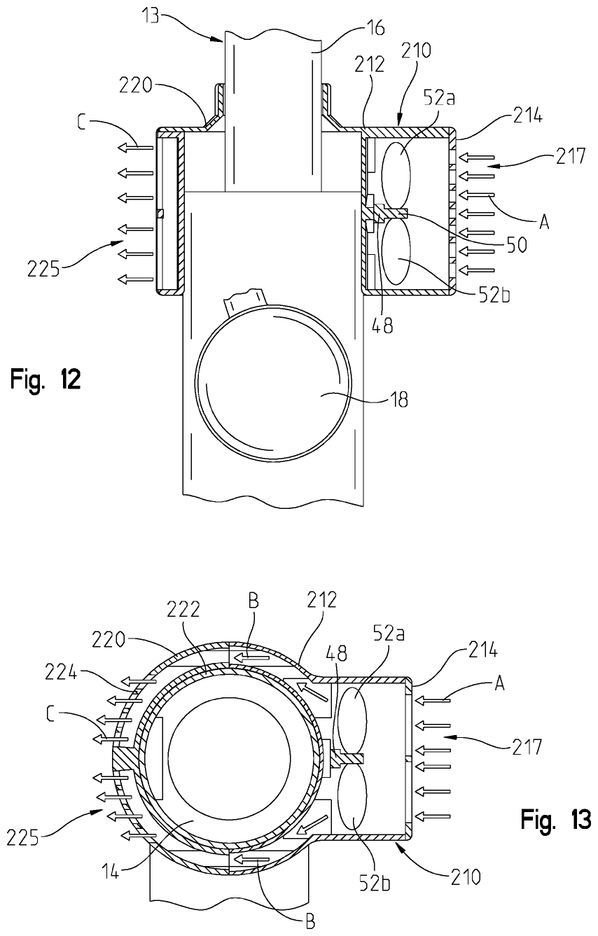

The second fan housing 220 includes a plurality of openings 224 defining an air outlet 225. Illustratively, the openings 224 face in the direction of the sink basin 22. Fan 210 works in a similar manner to fan 10 described in detail above. Air is pulled in through openings 216 of the air inlet 217 (arrows A). When operating, the fan 210 pushes the airflow through the second fan housing 120 (arrows B) around the circumference of the hub 14, and out the openings 124 of the air outlet 225 (arrows C) (FIGS. 12 and 13).

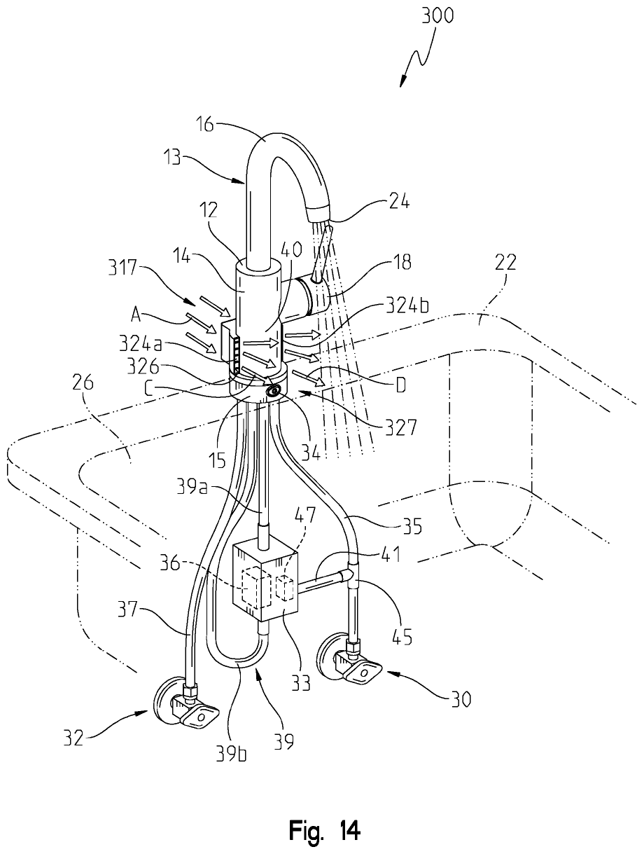

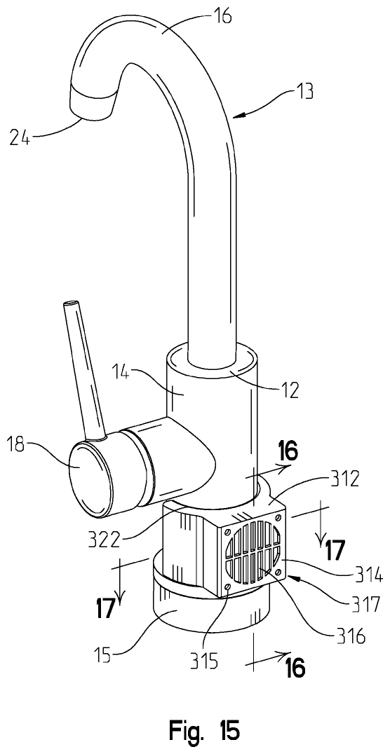

FIGS. 14-17 show another illustrative embodiment ozone faucet system 300 including many similar elements of the ozone faucet system 10 as detailed above. As such, in the following description, similar features are identified with like reference numbers.

A fan 310 is illustratively positioned on the outer surface 40 of the hub 14. A fan housing 312 receives the motor 48, the shaft 50, and the propeller 52. A rear cover 314 of the fan housing 312 includes a plurality of openings 316 defining an air inlet 317. The rear surface 314 is attached to the fan housing 312 via conventional methods, such as, for example, screws 315. Illustratively, there are four screws 315 that couple the rear cover 314 to the housing 312. The fan housing 312 includes an arcuate section 322 configured to match the geometry of the hub 14 so that the fan housing 312 can be coupled to the hub 14. In one illustrative embodiment, the fan housing 312 is integrated into the hub 14. In another illustrative embodiment, the fan housing 312 is separate from the hub 14 and attached to the hub 14 via conventional methods. This allows fan 110 to be added onto an existing faucet 12. In yet other illustrative embodiments, the fan housing 312 may be coupled to the spout 16, or to other components of the faucet 12, or positioned in spaced relation to the faucet 12.

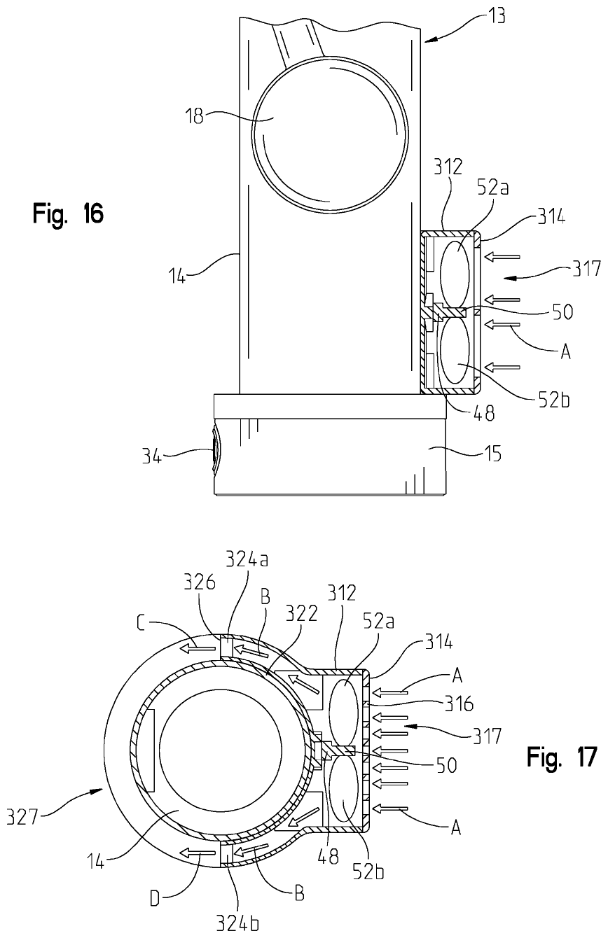

The fan housing 312 includes a plurality of openings 324 on a front surface 326 defining an air outlet 327. Illustratively, the openings 324a and 324b face in the direction of the sink basin 22 and are positioned on opposite sides of the hub 14. Fan 310 works in a similar manner to fan 10 described in detail above. Air is pulled in through openings 316 of the air inlet 317 (arrows A). When operating, the fan 310 pushes the airflow through the fan housing 312 (arrows B) around the circumference of the hub 14, and out the openings 324a and 324b of the air outlet 327 (arrows C and D) (FIGS. 16 and 17).

While the fans 20, 110, 210, 310 detailed above are shown coupled to the respective hubs 14, it should be appreciated that the fans 20, 110, 210, 310 may be supported in other locations, both on the faucet 12 or in spaced relation thereto. For example, the fans 20, 110, 210, 310 may be operably coupled to the respective spouts 16. As such, the fans 20, 110, 210, 310 may be supported for rotation with the spout 16, wherein the air outlets are configured to direct air flow to water discharged from the water outlet 24. In other illustrative embodiments, the fan 20, 110, 210, 310 may be located in the sink deck 22 (e.g., within an opening), or supported on the sink deck 22 in spaced relation to the faucet 12. In such illustrative embodiments, the fan 20, 110, 210, 310 is still in communication with the controller 60.

Although the invention has been described in detail with reference to certain preferred embodiments, variations and modifications exist within the spirit and scope of the invention as described and defined in the following claims.

What is claimed is:

1. A faucet system comprising:
a faucet including a faucet body having a spout configured to deliver fluid from an outlet;
a water treatment device fluidly coupled to the faucet;
a controller in electrical communication with the water treatment device and configured to control the water treatment device;
an air movement device supported by the faucet body and in electrical communication with the controller; and
wherein an air outlet of the air movement device is directed to water delivered from the outlet of the spout.

2. The faucet system of claim 1, wherein the air movement device comprises a fan, the fan including an air inlet spaced apart from the air outlet, a motor, a shaft, and a propeller.

3. The faucet system of claim 2, wherein the water treatment device is an ozone generator configured to provide ozone in the water.

4. The faucet system of claim 3, wherein the controller is configured to activate the fan motor when the ozone generator is operating.

5. The faucet system of claim 3, further comprising:
a sensor operably coupled to the spout and configured to measure ozone gas created by the ozone generator; and
wherein the controller is in electrical communication with the sensor and configured to control the fan motor based on the level of ozone gas measured by the sensor.

6. The faucet system of claim 2, further comprising a hub supporting the spout, a valve control handle supported on a first side of the hub, and wherein the fan is supported on a second side of the hub diametrically opposed to the valve control handle.

7. The faucet system of claim 1, further comprising a user input device supported by the faucet body and configured to provide an electrical signal to the controller to activate the water treatment device.

8. The faucet system of claim 7, wherein the user input device is a push button.

9. The faucet system of claim 1, further comprising a hub rotatably supporting the spout, and the air movement device is supported to rotate with the spout.

10. A faucet system comprising:
a faucet including a spout having a water outlet;
an ozone generator fluidly coupled to the faucet and configured to provide ozone in water delivered from the water outlet;
a controller operably coupled to the ozone generator; and
a fan operably coupled to the controller, the fan including an air inlet, an air outlet, an electric motor, a shaft rotatably supported by the motor, and a propeller operably coupled to the shaft and positioned intermediate the air inlet and the air outlet.

11. The faucet system of claim 10, wherein the outlet of the fan is directed to water delivered from the water outlet.

12. The faucet system of claim 11, wherein the faucet further includes a hub, and the spout is rotatably supported by the hub.

13. The faucet system of claim 12, wherein the fan is supported to rotate with the spout.

14. The faucet system of claim 10, wherein the controller is configured to activate the fan motor when the ozone generator is operating.

15. The faucet system of claim 10, further comprising:
a sensor operably coupled to the spout and configured to measure ozone gas created by the ozone generator; and
wherein the controller is in electrical communication with the sensor and configured to control the fan motor based on the level of ozone gas measured by the sensor.

16. The faucet system of claim 10, further comprising a user input device supported by the faucet body and configured to provide an electrical signal to the controller to activate the water treatment device.

17. The faucet system of claim 16, wherein the user input device is a push button.

18. A faucet comprising:
a hub;
a spout supported by the hub and including a water outlet;
a fan supported by the hub, the fan including an air inlet, an air outlet, an electric motor, a shaft rotatably supported by the motor, a propeller operably coupled to the shaft and positioned intermediate the air inlet and the air outlet; and
wherein the air outlet of the fan is directed to water delivered from the water outlet.

19. The faucet of claim 18, further comprising an ozone generator fluidly coupled to the spout.

20. The faucet of claim 19, further comprising a controller in electrical communication with the ozone generator and configured to control the ozone generator.

21. The faucet of claim 20, wherein the controller is configured to activate the fan motor when the ozone generator is operating.

22. The faucet of claim 20, further comprising:
a sensor operably coupled to the spout and configured to measure ozone gas created by the ozone generator; and
wherein the controller is in electrical communication with the sensor and configured to control the fan motor based on the level of ozone gas measured by the sensor.

23. The faucet of claim 20, further comprising a user input device supported by the hub and configured to provide an electrical signal to the controller to activate the ozone generator.

24. The faucet of claim 23, wherein the user input device is a push button.
